(19) United States
(12) Patent Application Publication
(10) Pub. No.: US 2007/0003831 A1
(43) Pub. Date: Jan. 4, 2007

(54) Construction and operation of an oilfield molten salt battery

(76) Inventors: Michael L. Fripp, Carrollton, TX (US); Syed Hamid, Dallas, TX (US); Josip Caja, Knoxville, TN (US); Mario Caja, Knoxville, TN (US)

Correspondence Address: SMITH IP SERVICES, P.C., 660 NORTH CENTRAL EXPRESSWAY, SUITE 230, PLANO, TX, 75074, US

(21) Appl. No.: 11/174,257

(22) Filed: Jul. 1, 2005

(51) Int. Cl. H01M 2/02; H01M 2/08; H01M 2/06; H01M 10/44; H01M 10/50; H02J 7/00

(52) U.S. Cl. 429/164; 429/176; 429/181; 429/50; 429/120; 320/160; 320/137

(57) ABSTRACT

Construction and operation of an oilfield molten salt battery. A battery includes an outer case, an elongated mandrel positioned within the outer case, and the mandrel being an electrical component of the battery. Another battery includes an electrical pickup, and a polymer insulator providing insulation between the outer case and the pickup. A method of charging a battery for use in a subterranean well includes the steps of: providing the battery including an electrolyte, and anode and cathode electrodes, the electrolyte being a molten salt comprising lithium salt, and at least one of the electrodes comprising lithium atoms; positioning the battery within a wellbore; and then charging the battery. Another method includes the steps of: heating the lithium ion molten salt battery; then charging the battery; and then positioning the battery within a wellbore.

### BACKGROUND

The present invention relates generally to equipment utilized and operations performed in conjunction with a subterranean well and, in an embodiment described herein, more particularly provides improved construction and operation of batteries used in the oilfield.

Rechargeable batteries have been proposed in the past for use in a downhole environment. However, none of these has been successful in actual practice. For example, a rechargeable battery having a solid lithium metal electrode and a polymer electrolyte has been disclosed. Unfortunately, such solid lithium metal electrodes require extensive safety precautions be taken, and have reduced cycle life due to problems with replating and formation of lithium dentrites which can cause electrical shorts.

In addition, satisfactory construction techniques have yet to be devised for sufficiently ruggedizing batteries used in a downhole environment, and satisfactory methods have not been disclosed for charging/recharging molten salt batteries used in a downhole environment. Thus, it may be seen that there is a need for improved construction and operation of oilfield molten salt batteries. It is one of the objects of the present invention to provide such improved battery construction and operation.

### SUMMARY

In carrying out the principles of the present invention, a molten salt battery suitable for use in the oilfield is provided, along with methods of operation thereof, which solve at least one problem in the art. One example is described below in which the battery construction provides for support of an electrode assembly within an outer case of the battery. Another example is described below in which the battery is heated and then charged at the surface prior to being positioned downhole and discharged.

In one aspect of the invention, a battery for use in a subterranean well is provided. The battery includes an outer case and an elongated mandrel positioned within the outer case. The mandrel is an electrical component of the battery.

In another aspect of the invention, a battery for use in a subterranean well is provided which includes an outer case, an electrical pickup and a polymer insulator providing electrical insulation between the outer case and the electrical pickup. The insulator may also seal an electrolyte within the outer case. The insulator may be compressed using a cap for the outer case, or using the electrical pickup.

In a further aspect of the invention, a method of charging a battery for use in a subterranean well is provided which includes the steps of: providing the battery including an electrolyte, and anode and cathode electrodes, the electrolyte comprising a molten salt (e.g., containing lithium salts), and at least one of the electrodes comprising lithium; positioning the battery within a wellbore of the well; and then charging the battery. The electrodes may have the lithium, e.g., in the form of lithium metal or lithiated compounds.

In a still further aspect of the invention, another method of charging a battery for use in a subterranean well is provided which includes the steps of: providing the battery including an electrolyte, and anode and cathode electrodes, the electrolyte comprising a molten salt (e.g., containing lithium salts); heating the battery; then charging the battery; and then positioning the battery within a wellbore of the well. The electrodes may have the lithium, e.g., in the form of lithium metal or lithiated compounds.

Other aspects of the invention include charging a molten salt battery downhole while controlling voltage across the battery, and coupling an electrode of a battery to an outer case with a direct connection between the electrode and the outer case.

These and other features, advantages, benefits and objects of the present invention will become apparent to one of ordinary skill in the art upon careful consideration of the detailed description of representative embodiments of the invention hereinbelow and the accompanying drawings, in which similar elements are indicated in the various figures using the same reference numbers.

### BRIEF DESCRIPTION OF THE DRAWINGS

FIG. 1 is a schematic partially cross-sectional view of a method embodying principles of the present invention;

FIG. 2 is an enlarged scale schematic cross-sectional view of a battery construction usable in the method of FIG. 1, the battery construction embodying principles of the invention;

FIG. 3 is a further enlarged scale schematic cross-sectional view of an electrode connection in the battery construction of FIG. 2;

FIG. 4 is a schematic cross-sectional view of a first alternate electrode connection in the battery construction of FIG. 2;

FIG. 5 is a schematic scale cross-sectional view of a second alternate electrode connection in the battery construction of FIG. 2; and

FIG. 6 is a schematic partially cross-sectional view of a battery charging method embodying principles of the invention.

### DETAILED DESCRIPTION

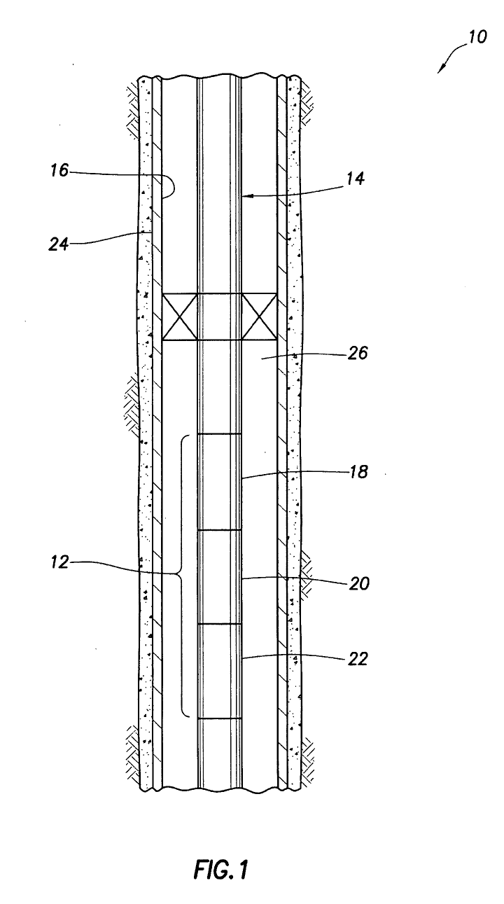

Representatively illustrated in FIG. 1 is a method 10 which embodies principles of the present invention. In the following description of the method 10 and other apparatus and methods described herein, directional terms, such as “above”, “below”, “upper”, “lower”, etc., are used for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention. The embodiments are described merely as examples of useful applications of the principles of the invention, which is not limited to any specific details of these embodiments.

As depicted in FIG. 1, a well tool 12 is interconnected in a tubular string 14 and is positioned within a wellbore 16. The well tool 12 is schematically illustrated as including an electrical generator section 18, a battery section 20 and a tool section 22 attached to each other in the tubular string 14.

However, it should be clearly understood that it is not necessary for the well tool 12 to include each of these sections 18, 20, 22, and the sections could be positioned separate from each other or integrated with each other as desired. For example, the generator section 18 may not be used if recharging downhole is not desired, the battery section 20 and tool section 22 could be integrated into a single section, etc.

In addition, it is not necessary for any or all of the sections 18, 20, 22 to be interconnected in the tubular string 14. The sections 18, 20, 22, or any of them, could instead be interconnected in a casing string 24, positioned in an annulus 26 between the strings 14, 24, or otherwise positioned in the well.

The tubular string 14 could be any type of structure in the well, such as a drill string, production tubing string, coiled tubing string. The tubular string 14 could also be replaced by structures such as a wireline, electric line, autonomous vehicle, etc. for conveying the well tool 12 into the well.

The generator section 18 is used to generate electrical energy for operation of the tool section 22, and to charge/recharge one or more batteries in the battery section 20. The generator section 18 could, for example, generate electrical energy in response to fluid flow through or into the tubular string 14, or in response to vibration of the tubular string (such as during drilling or production operations, etc.).

Alternatively, the generator section 18 could generate electricity via consumption of fuel (e.g., using a fuel cell) or using radioactivity (e.g., using a nuclear power source). As another alternative, the generator section 18 could be replaced by electrical lines extending to the surface or other remote location. Thus, the generator section 18 could be any source of electrical power, including another battery.

Examples of downhole generators are described in U.S. Pat. Nos. 6,504,258 and 6,717,283, U.S. Published Application No. 2002/96887, U.S. patent application Ser. Nos. 10/826,952 and 10/825,350, and International Patent Application Nos. PCT/US2000/31621 and PCT/US2005/003911. The disclosures of these prior patents and applications are incorporated in their entireties/herein by this reference.

The tool section 22 may include any type of tool which may be of use in the well. For example, the tool section 22 could include a production valve and/or choke, a well testing tool, a sensor (such as a pressure, temperature, water cut, radioactivity, acoustic, electromagnetic, resistivity and/or capacitance sensor, etc.), a telemetry device (such as a wired or wireless transmitter and/or receiver), a packer or other sealing and/or anchoring device, a pump, a separator, etc. and any combination of well tools.

The battery section 20 is used to store electrical energy for operation of the tool section 22. One or more batteries in the battery section 20 may be charged and/or recharged using electrical energy generated by the generator section 18. If the generator section 18 is not used, then the batteries could be charged at the surface prior to being installed in the well, and then the batteries could be discharged downhole to operate the tool section 22.

In one preferred embodiment, the tool section 22 includes at least one sensor and a wireless telemetry device, and the tubular string 14 is a production tubing string. During completion and/or production operations, the sensor senses a downhole parameter and the telemetry device transmits indications of the downhole parameter to a remote location (such as the earth's surface or another location in the well). The battery section 20 provides electrical power for the tool section 22 to perform these functions. The generator section 18 maintains a battery of the battery section 20 in a charged condition. Alternatively, or in addition, the battery section 20 may provide load-leveling for the generator section 18.

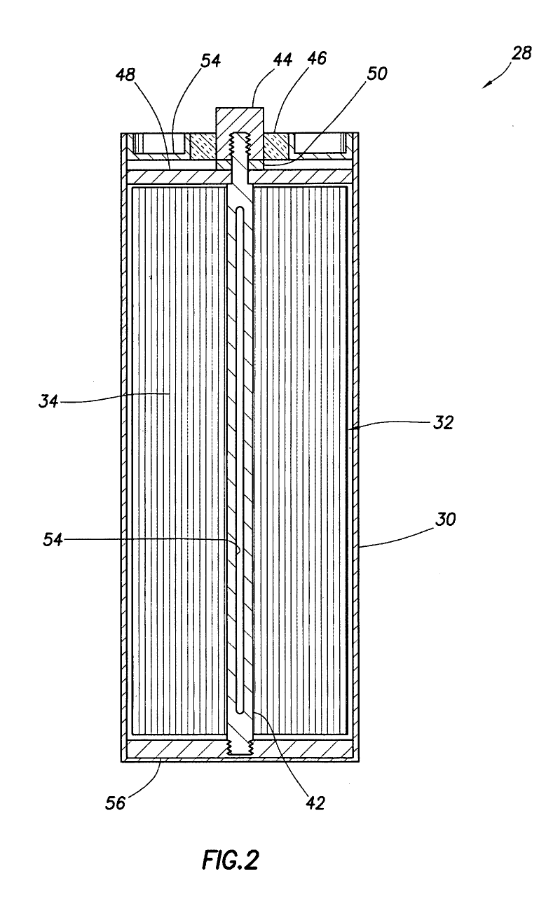

Referring additionally now to FIG. 2, a battery 28 embodying principles of the invention is representatively illustrated. The battery 28 could be used in the battery section 20 in the method 10, or it could be used in other methods. The battery 28 is uniquely constructed to withstand the harsh downhole environment, enhance safety of operations, and to enhance charging/recharging.

As depicted in FIG. 2, the battery 28 includes an outer case 30 having an electrode assembly 32 disposed therein. An electrolyte 34 is contained in the outer case 30 and contacts the electrode assembly 32, so that electrical energy may be stored in the battery 28.

Preferably, the electrode assembly 32 includes an anode comprising a metallic material selected from Li₄Ti₅O₁₂, LiWO₂ and LiMoO₂. The electrode assembly 32 preferably includes a cathode comprising a metallic material selected from LiₓMn₂O₄, LiₓCoO₂, modified LiₓMn₂O₄, LiₓMn₂₋ₓCuₓO₄ wherein 0.1<x<0.5, LiM_{0.02}Mn_{1.98}O₄ wherein M can be B, Cr, Fe and Ti, a transition metal oxide, an electrochemically active conductive polymer, LiFePO₄, LiCoPO₄, LiMnPO₄, or a combination thereof. Thus, each of the anode and cathode electrodes preferably comprises lithium atoms.

The electrolyte 34 is preferably an ionic liquid composed entirely of ions (cations and anions) and lithium salts. Molten salts are mixtures of anions and cations, which mixtures are liquid at temperatures below the individual melting point of each individual compound.

The electrolyte 34 can be in the form of a pyrazolium cation-containing molten salt, an imidazolium cation-containing molten salt, or a combination thereof, and at least one Lewis acid or non-Lewis acid derived counter ion wherein the counter ion preferably includes bis(trifluoromethylsulfonyl)imide (CF₃SO₂)₂N (imide), bis(perfluoroethylsulfonyl)imide (CF₃CF₂SO₂)₂N (BETI), tris(trifluoromethylsulfonyl)methide (CF₃SO₂)₃C (methide), trifluoromethylsulfonate CF₃SO₃ (triflate, TF), or a combination thereof, together with a dissolved lithium salt. The electrolyte 34 preferably exhibits an oxidation limit of greater than about 5 volts vs. lithium, reduction voltage less than 1.5 volts vs. lithium, and is thermally stable to at least about 300° C.

A similar battery electrochemistry is described in U.S. patent application Ser. No. 10/820,638, the entire disclosure of which is incorporated herein by this reference.

Thus, the battery 28 preferably uses a lithium-ion electrochemistry, where lithium ions intercalate and deintercalate between the anode and cathode. The battery 28 uses electrodes that can reach higher temperatures by incorporating anode materials which intercalate/deintercalate lithium ions at voltages higher than the reduction voltage of the electrolyte 34. The result is a battery which does not need a passivation layer on the anode.

Preferably, the anode and cathode of the battery 28 do not have the same capacity. Instead, one of these has more charge, which means that some of that electrode remains unused during the charging/discharging of the battery 28. Even though some of the electrode material is thereby unused, this unequal ratio of capacity improves the cycle life of the battery 28. The cathode preferably has approximately 1.25 or more times the capacity of the anode.

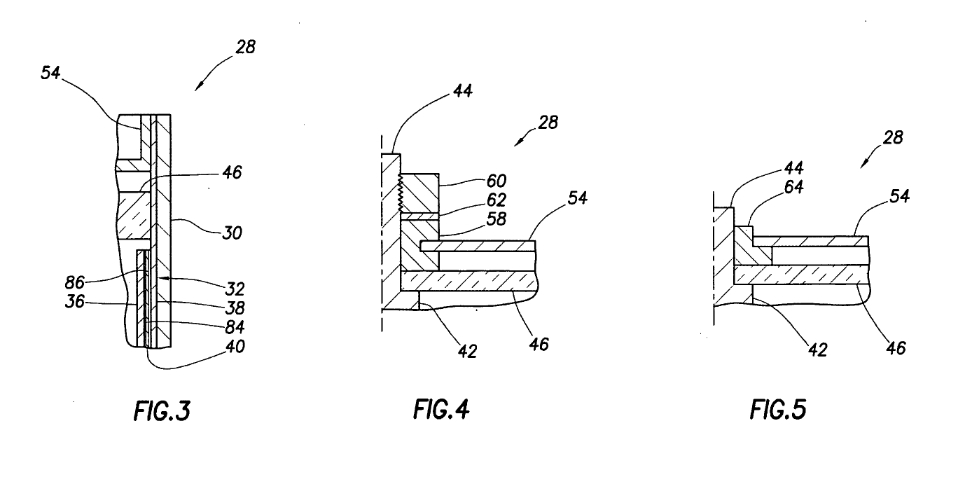

The electrode assembly 32 is preferably in the form of a specially constructed multi-layered assembly having the cathode 84 and its associated current collector 36 formed on at least one side, the anode 86 and its associated current collector 38 formed on the opposite side, and a porous insulating separator 40 between the anode and cathode. In an enlarged cross-section of the assembly 32 depicted in FIG. 3, the cathode 84 is on an inner side of the current collector 36, the anode 86 is on an inner side of the current collector 38, and the separator 40 is positioned between the anode and cathode. Preferably, the cathode current collector 36 is made of a copper material and the anode current collector 38 is made of an aluminum material, each of these comprising lithium atoms as described above, but other materials may be used if desired.

Referring again to FIG. 2, the electrode assembly 32 is preferably spirally wrapped or wound about an elongated cylindrical metal mandrel 42 prior to being installed in the outer case 30. However, this configuration is not necessary, since the electrode assembly 32 could instead be stacked or arranged prismatically, etc. in the outer case 30.

The mandrel 42 provides several unique benefits in the battery 28. The mandrel 42 is preferably electrically connected to the anode current collector 38 and can thereby serve as a more robust electrical pickup (without requiring the delicate thin contacts, such as wires or tabs, used in conventional battery construction). The mandrel 42 radially supports the electrode assembly 32 from within, thereby reducing or eliminating movement of the electrode assembly in the outer case 30. The mandrel 42 provides a secure central structure for mounting a separate electrical pickup 44, insulators 46, 48, spacer 50, etc.

The mandrel 42 is preferably made of an aluminum alloy, although other materials may be used if desired. A longitudinally extending slot 52 formed in the mandrel 42 provides a convenient location for inserting the electrode assembly 32 therein, which also makes a mechanical type of electrical connection to the cathode electrode 38.

Of course, the current collector 36 could also, or alternatively, be electrically connected to the mandrel 42 by welding, brazing, soldering, bonding with an electrically conductive adhesive, crimping, clamping or otherwise fastening, etc. Electrical contact between the mandrel 42 and the current collector 36 could be enhanced by using a conductive fluid, conductive polymer or soft metal to decrease the electrical resistance of the connection. Fluid isolation (such as a PTFE o-ring or other type of seal, silicone sealant, etc.) may also be used to prevent ingress of the electrolyte 34 between the mandrel 42 and the current collector 36.

Although the mandrel 42 is described above as being an electrical component of the battery 28 and remaining in the battery after installation of the electrode assembly 32, note that this is not necessary in keeping with the principles of the invention. The mandrel 42 could instead be removed from the electrode assembly 32 before or after the electrode assembly is installed in the outer case 30.

The electrical pickup 44 is preferably made of a refractory metal (such as tantalum) for compatibility with the insulator 46, which is preferably made of glass. The pickup 44 serves as a convenient electrical contact whereby the battery 28 may be electrically connected to other electrical components of the well tool 12.

The insulator 46 provides electrical insulation between the pickup 44 and a cap 54 for the outer case 30. The insulator 46 also serves as a seal to prevent the electrolyte 34 from leaking out of the battery 28.

The insulator 48 provides electrical insulation between the cap 54 and the electrode assembly 32. The insulator 48 also prevents upward movement of the electrode assembly 32 and centralizes the mandrel 42 within the outer case 30. Furthermore, the insulator 48 reduces loading on the insulator 46 due to lateral vibratory displacement of the battery 28.

A somewhat similar insulator 56 at a lower end of the mandrel 42 provides electrical insulation between the outer case 30 and each of the mandrel and the electrode assembly 32, prevents downward displacement of the electrode assembly, and centralizes the lower end of the mandrel in the outer case. Preferably, the insulators 48, 56 are made of a suitable insulative and chemically appropriate material (such as Torlon®).

The outer case 30 is preferably made of metal (such as steel), but other materials (such as electrically conductive polymers, etc.) could be used if desired. Note that it is not necessary for the outer case 30 to be rigid, since the electrolyte 34 preferably has a relatively low vapor pressure, the battery 28 can be soft-sided, with a flexible outer case.

In this manner, the shape of the battery 28 could be manipulated to fit conveniently within the tight confines and complex geometries which may be found in downhole applications. In addition, a soft-sided battery 28 could be installed in a non-pressure tight environment where the battery would experience hydrostatic pressure in the well. This would allow for more battery volume, since less housing material would be needed for pressure isolation. The battery 28 could be provided with a bellows or other pressure equalization means to allow for balancing pressures between the interior and exterior of the battery.

If the battery 28 is soft-sided, then the outer case 30 could be a multi-layer laminate with at least one metallic layer and at least one polymeric layer (made, for example, from an elastomeric material). The metallic layer would prevent gas diffusion and the polymeric layer would add puncture resistance.

It also is not necessary for the outer case 30 to be cylindrical-shaped. For example, the outer case 30 could be shaped similar to a toroid, so that it can encircle a passage formed through the tubular string 14 or casing string 24. In that case, the mandrel 42 could be tubular-shaped, so that the passage extends through the mandrel.

In the embodiment illustrated in FIG. 2, the outer case 30 serves as an electrical pickup for the anode current collector 38. As depicted in FIG. 3, the current collector 38 is preferably retained between an upper end of the outer case 30 and the cap 54.

For example, an upwardly extending tab may be formed on the current collector 38 on an outer wrap of the electrode assembly 32. When the cap 54 is installed in the outer case 30, the tab on the current collector 38 is positioned between the cap and the outer case. The cap 54 may be crimped to the outer case 30, in which case this crimp may also serve to electrically connect the current collector 38 to the outer case. Alternatively, or in addition, welding, brazing, soldering, bonding with electrically conductive adhesive, or any other method may be used to electrically connect the current collector 38 to the outer case 30 and/or to secure the cap 54 to the outer case.

Referring additionally now to FIG. 4, an alternate construction of the battery 28 is representatively illustrated. This alternate construction is similar in most respects to the construction of the battery 28 depicted in FIG. 2. However, a polymer insulator 58 is used in place of the glass insulator 46.

The insulator 58 may include any type of polymer, combinations of polymers, or combinations of polymers and non-polymers. For example, the insulator 58 may include elastomers, non-elastomers, plastics, resilient and non-resilient polymers, Viton®, Torlon®, PTFE, silicone, glues, sealants, hardenable substances, etc.

The insulator 58 is “energized” or compressed to form a seal between the mandrel 42 and the cap 54 to prevent the electrolyte 34 from leaking out of the battery 28. A nut 60 is threaded onto the mandrel 42 and tightened to compress the insulator 58 via a washer 62.

By using the polymer insulator 58, any need for the electrical pickup 44 to be made of a refractory metal is eliminated. Preferably, the electrical pickup 44 is formed on an upper end of the mandrel 42 in the construction depicted in FIG. 4, although it could be formed on another element, such as the nut 60 or the washer 62, if desired.

Referring additionally now to FIG. 5, another alternate construction of the battery 28 is representatively illustrated. This construction is very similar to the alternate construction depicted in FIG. 4. However, a polymer insulator 64 used to insulate and seal between the mandrel 42 and the cap 54 is differently configured, and the nut 60 and washer 62 are not used.

The insulator 64 is “energized” or compressed between the mandrel 42 and the cap 54 at the time the cap is installed in the outer case 30. That is, the cap 54 itself compresses the insulator 64. The attachment between the cap 54 and the outer case 30 (e.g., by crimping, welding, brazing, bonding, etc. as described above) maintains a compressive force on the insulator 64.

Some of the benefits of this alternate configuration are that fewer components are used, yielding a simpler construction, and fewer steps are needed to assemble the battery 28.

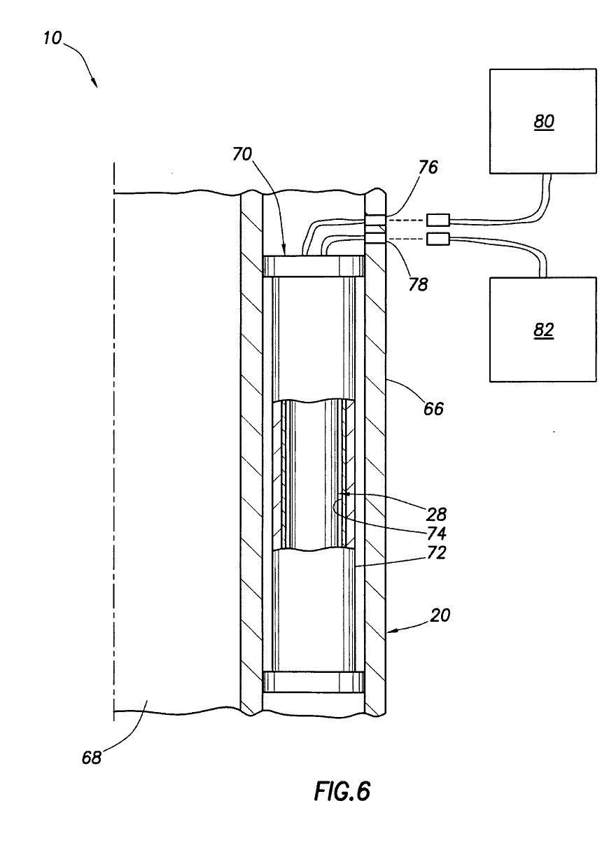

Referring additionally now to FIG. 6, the battery 28 is representatively illustrated installed within an outer housing 66 of the battery section 20. When the battery section 20 is installed in the well as depicted in FIG. 1, the outer housing 66 is exposed to well fluids.

The outer housing 66 may isolate the battery 28 and associated components from the well fluids or, if the battery 28 is soft-sided or includes a pressure equalization feature as described above, then the outer housing may permit the battery 28 to be exposed to well fluid pressure. Note that an internal passage 68 of the tubular string 14 extends through the outer housing 66 of the battery section 20, such that when the tubular string is installed in the well the outer housing may be exposed to well fluids in the passage 68 and in the annulus 26.

In order to increase diffusion of electrical energy storage in the battery 28, it may be preferable to charge/recharge the battery at the surface after it has been heated. As depicted in FIG. 6, the battery 28 is contained within a heating device 70 within the outer housing 66.

The heating device 70 includes an outer insulative shell 72 and an electrical resistance heater 74 on an inner side of the shell. The shell 72 could be made of any material (such as a composite or foamed material, etc.) having appropriate insulative properties. The heater 74 could be in the form of a film or resistance wire bonded to, or incorporated into, the shell 72.

However, it should be understood that any configuration of the heating device 70 may be used in keeping with the principles of the invention. For example, other types of heating devices may be used, and it is not necessary for the heating device to be installed in the outer housing 66, etc.

For convenience in charging the battery 28 prior to installing the battery section 20 in the well, the outer housing 66 is provided with connectors 76, 78 in its outer wall. The connector 76 is used to electrically connect to the heater 74 for heating the battery 28, and the connector 78 is used to connect to the battery 28 (e.g., to the electrical pickup 44 and outer case 30) for charging the battery.

A heater power and control system 80 is connected to the connector 76 at the surface to heat the battery 28. A temperature sensor (not shown) could be used in the heating device 70 to monitor the temperature of the battery 28 and to enable the heater power and control system 80 to heat the battery at a desired rate to a desired optimum temperature prior to charging. The system 80 may also maintain the battery 28 at the desired temperature during charging.

A charging/recharging power and control system 82 is connected to the connector 78 at the surface to charge/recharge the battery 28. Preferably, the battery 28 is charged after it has been heated to the desired optimum temperature, but this is not necessary in keeping with the principles of the invention. In addition, note that it is not necessary for the battery 28 to be heated and/or charged at the surface, since these operations could be performed downhole, for example, using the generator section 18 for electrical power to heat and/or charge the battery.

By providing the heating device 70 in the outer housing 66 of the battery section 20 with the externally accessible connectors 76, 78, the battery 28 may be conveniently charged/recharged at the surface prior to installing the battery section in the well. This eliminates any need to disassemble the battery section 20 to charge/recharge the battery 28.

Whether the battery 28 is charged at the surface or after it is installed in the well, various different methods may be used for charging the battery. When charging multiple batteries in series, precautions are preferably taken that minor variations in the batteries do not lead to one battery receiving more voltage than the other batteries.

The internal resistance of the battery 28 increases at the boundaries of the charge and discharge processes. If protections are not included, then some batteries can experience a damagingly high or damagingly low voltage.

To prevent damage from overcharging a battery 28, several protections may be used. An additive may be added to the battery 28 so that all of the charging current is used in a reversible cycle without increasing the voltage. This local oxidation/reduction cycle prevents overcharging. In NiCd rechargeable batteries, cadmium hydroxide is added to capture the produced oxygen that occurs during overcharging. Instead of an oxidation/reduction cycle, a concentration reaction could be used.

Electronic protection may be used, for example, a diode with a 2.5 volt voltage drop. The diode would stay closed until the battery 28 is fully charged, at which point the current will shunt around the battery. More complex protection circuits may be used, if desired.

A lower charging current may be used, in which case variations in the internal resistance of the batteries is less important. With a lower charging current, variations in internal resistance produce smaller voltage differences. However, lower charging current increases the time needed to charge the battery 28.

A lower charging voltage may be used, in which case the resistance variations in the batteries 28 will not exceed a damaging threshold. Alternatively, a relatively high charging current may be used initially until a voltage threshold is reached, at which point a lower charging current is used to complete the battery charge.

Proper charging/recharging and discharging of the battery 28 for optimal life, maximum capacity and efficient operation is accomplished by careful control of voltage and current across and through the battery. Since the internal resistance of the battery 28 changes with temperature, various charging methods may be optimal at corresponding various temperatures of the battery.

Several charging method options are described below. However, it should be clearly understood that other charging methods may be used in keeping with the principles of the invention.

A constant current may be maintained through the battery 28 during charging. Alternatively, the current may be changed in discreet steps or gradually varied. Current may be applied until a predetermined voltage across the battery 28 is achieved, preferably 2.5 volt for the electrochemistry described above.

A constant potential or voltage may be maintained across the battery 28 during charging. This may be accomplished using a set predetermined voltage, or modified by using a constant initial and/or finish current through the battery 28. If a set predetermined voltage is used, then the current flowing through the battery 28 will decrease exponentially with time.

If modified with a constant initial and/or finish current, then the battery charger is preferably set for the predetermined voltage, and the initial current is limited by means of a series resistor in the charger circuit. The initial current is maintained constant until the predetermined voltage is reached across the battery 28. The series resistor can be switched during the charging process to optimize the charging rate.

A greater voltage may be used during an initial portion of the charging process, with the voltage gradually decreasing as the battery 28 is charged. Gradually decreasing current through the battery 28 could also be used. As an alternative, the charging voltage and/or current may be gradually increased during the charging process. As another alternative, the charging and/or current may be increased or decreased in discreet steps during the charging process.

Electrical energy applied to the battery 28 may be periodically pulsed during the charging process. The battery charger may be periodically isolated from the battery 28, and the open circuit impedance-free voltage of the battery may be measured. If the open circuit voltage is above a predetermined value (such as 2.45 volt), then the charger will not deliver further electrical energy to the battery 28. When the open circuit voltage decays below the predetermined value, then the charger applies electrical energy to charge the battery 28.

The applied electrical energy may be in the form of a DC pulse for a fixed time period, but any of the other battery charging methods described herein could be used instead. Preferably, the duration of the open circuit and the duration of the application of electrical energy are selected so that when the battery 28 is fully charged, the time for the open circuit voltage to decay to below the predetermined value is the same as the duration of the pulse or other application of electrical energy.

Another possible method for charging the battery 28 is trickle charging. A continuous constant current through the battery 28 is used to maintain the battery in a fully charged condition. This replaces the electrical energy lost through self-discharge, as well as through electrical loads. Float charging (constant voltage applied across the battery 28) may alternatively be used to maintain the battery in a fully charged condition.

If the charging/recharging or discharging is being performed at a low ambient temperature (such as at the earth's surface), then a heater (such as the heater 74 described above) may be used to increase the mobility of the electrolyte 34. By heating the battery 28, the internal resistance will decrease, the ionic diffusion rate will increase, and the battery will be able to accept/produce electrical energy at a higher rate.

The operational state of charge of the battery 28 can be determined by noting the open circuit voltage of the battery, the amount of electrical energy that the battery has through the integration of electrical energy that has flowed to and from the battery, and by an AC impedance measurement.

Note that the battery 28 can be charged/recharged at the surface or in a well. If the battery 28 is to be charged only in a well, then the heating device 70 may not be used. Of course, the battery 28 could be charged at the surface, and then discharged and recharged in a well, if desired.

It may now be fully appreciated that the battery 28 is well suited for use in a subterranean well. The battery 28 electrochemistry should be operable at temperatures exceeding 100° C. Indeed, a prototype constructed by the applicants has been satisfactorily charged and discharged repeatedly from room temperature to 150° C.

Of course, a person skilled in the art would, upon a careful consideration of the above description of representative embodiments of the invention, readily appreciate that many modifications, additions, substitutions, deletions, and other changes may be made to these specific embodiments, and such changes are within the scope of the principles of the present invention. Accordingly, the foregoing detailed description is to be clearly understood as being given by way of illustration and example only, the spirit and scope of the present invention being limited solely by the appended claims and their equivalents.

What is claimed is:

1. A battery for use in a subterranean well, the battery comprising:
an outer case;
an elongated mandrel positioned within the outer case; and
the mandrel being an electrical component of the battery.

2. The battery of claim 1, further comprising an electrode assembly attached to the mandrel.

3. The battery of claim 2, wherein the mandrel is electrically connected to an electrode of the electrode assembly.

4. The battery of claim 2, wherein the mandrel supports the electrode assembly within the outer case.

5. The battery of claim 1, wherein the mandrel is centralized within the outer case, and further comprising at least one electrode positioned between the mandrel and outer case.

6. A battery for use in a subterranean well, the battery comprising:
an outer case;
an electrical pickup; and
a polymer insulator providing electrical insulation between the outer case and the electrical pickup.

7. The battery of claim 6, wherein the insulator seals an electrolyte within the outer case.

8. The battery of claim 6, wherein the electrical pickup is attached to a mandrel positioned within the outer case.

9. The battery of claim 8, wherein the electrical pickup biases the insulator against the mandrel.

10. The battery of claim 8, wherein a cap for the outer case biases the insulator against the mandrel.

11. A method of charging a battery for use in a subterranean well, the method comprising the steps of:
providing the battery including an electrolyte, and anode and cathode electrodes, the electrolyte being a molten salt with a dissolved lithium salt, and at least one of the electrodes comprising lithium atoms;
positioning the battery within a wellbore of the well; and
then charging the battery.

12. The method of claim 11, wherein the charging step further comprises controlling a voltage across the battery while the battery is being charged.

13. The method of claim 11, wherein the positioning step further comprises enclosing the battery within an outer housing, and then exposing the outer housing to well fluids within the wellbore.

14. The method of claim 11, wherein the charging step further comprises at least one of: maintaining a constant current through the battery, maintaining a constant voltage across the battery, varying voltage across the battery, varying current through the battery, varying electrical energy applied to the battery in discreet steps, periodically pulsing electrical energy to the battery, trickle charging and float charging.

15. The method of claim 11, further comprising the step of heating the battery prior to the charging step.

16. The method of claim 11, further comprising the step of sealing the battery within an outer housing of a well tool.

17. A method of charging a battery for use in a subterranean well, the method comprising the steps of:
providing the battery including an electrolyte, and anode and cathode electrodes, the electrolyte being a molten salt comprising a lithium salt;
heating the battery;
then charging the battery; and
then positioning the battery within a wellbore of the well.

18. The method of claim 17, wherein and at least one of the electrodes comprises lithium atoms.

19. The method of claim 17, wherein the charging step further comprises controlling a voltage across the battery while the battery is being charged.

20. The method of claim 17, wherein the positioning step further comprises enclosing the battery within an outer housing, and then exposing the outer housing to well fluids within the wellbore.

21. The method of claim 17, wherein the charging step further comprises at least one of: maintaining a constant current through the battery, maintaining a constant voltage across the battery, varying voltage across the battery, varying current through the battery, varying electrical energy applied to the battery in discreet steps, periodically pulsing electrical energy to the battery, trickle charging and float charging.

22. The method of claim 17, further comprising the step of sealing the battery within an outer housing of a well tool.
